(19) United States
(12) Patent Application Publication
(10) Pub. No.: US 2025/0125071 A1
(43) Pub. Date: Apr. 17, 2025

(54) CABLE

(71) Applicants: Fuyu Electronic Technology (Huai’an) Co., Ltd., Huai’an (CN); FOXCONN INTERCONNECT TECHNOLOGY LIMITED, Grand Cayman (KY)

(72) Inventors: A-NAN YANG, Huaian (CN); HAN-RUN XIE, Huaian (CN); LU-YU CHANG, New Taipei (TW)

(21) Appl. No.: 18/910,509

(22) Filed: Oct. 9, 2024

(30) Foreign Application Priority Data
Oct. 11, 2023 (CN) 202322735457.4

(51) Int. Cl. H01B 11/20; H01B 3/30; H01B 11/00

(52) U.S. Cl. CPC H01B 11/203; H01B 11/002; H01B 3/30

(57) ABSTRACT

A cable includes: a pair of core wires each including an inner conductor and an inner insulating layer covering the inner conductor; an insulating layer covering the pair of core wires; a shielding layer covering the insulating layer; and an outer layer covering the shielding layer; wherein the inner insulating layer includes a first inner insulating layer and a second inner insulating layer, the first inner insulating layer is made of solid material and covers the inner conductor by extrusion molding, the second inner insulating layer is made of foamed material and wraps the first inner insulating layer in a winding way, the insulating layer includes a first insulating layer and a second insulating layer, the first insulating layer covers the pair of core wires in a winding way, and the second insulating layer covers the first insulating layer by extrusion molding.

### BACKGROUND OF THE INVENTION

### Field of the Invention

The present invention relates generally to a cable, and more particularly to a cable used to transmit high frequency signals.

### Description of Related Arts

CN Patent No. 212434276U discloses a cable comprising a pair of core wires arranged in parallel, a shielding layer covering the pair of core wires, and an insulating outer layer covering the shielding layer. The insulating layer of the core wire is made of one material, which makes it difficult for the cable to have a stable manufacturing process, a small dielectric constant, and stable electrical characteristics.

Therefore, it is necessary to provide a cable with small dielectric constant and stable electrical properties.

### SUMMARY OF THE INVENTION

A main object of the present invention is to provide a cable with a smaller dielectric constant and better electrical properties.

To achieve the above object, a cable comprises: a pair of core wires each including an inner conductor and an inner insulating layer covering the inner conductor; an insulating layer covering the pair of core wires; a shielding layer covering the insulating layer; and an outer layer covering the shielding layer; wherein the inner insulating layer includes a first inner insulating layer covering the inner conductor and a second inner insulating layer covering the first inner insulating layer, the first inner insulating layer is made of solid material and covers the inner conductor by extrusion molding, the second inner insulating layer is made of foamed material and wraps the first inner insulating layer in a winding way, the insulating layer includes a first insulating layer and a second insulating layer, the first insulating layer covers the pair of core wires in a winding way, and the second insulating layer covers the first insulating layer by extrusion molding.

Compared to prior art, in the present invention, the inner insulating layer includes a first inner insulating layer and a second inner insulating layer, the first inner insulating layer is made of solid material and is extruded and molded outside the inner conductor to make the impedance fluctuation of the cable smaller, the second inner insulating layer is wrapped around the first inner insulating layer with foamed material to make the dielectric constant of the cable smaller, furthermore, the insulating layer includes a first insulating layer and a second insulating layer, the first insulating layer is wrapped around the pair of core wires to make the dielectric constant of the cable smaller, and the second insulating layer is extruded and molded outside on the first insulating layer, so that the cable has better bending resistance.

### BRIEF DESCRIPTION OF THE DRAWING

FIG. 1 is a cross-sectional view of a cable of the present invention.

### DETAILED DESCRIPTION OF THE PREFERRED EMBODIMENT

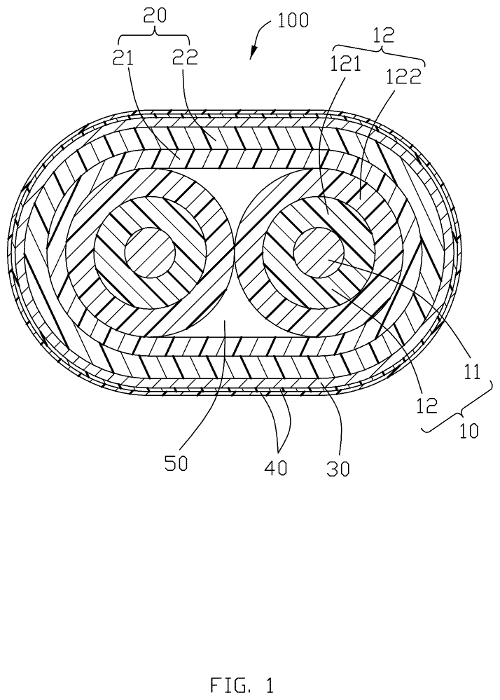

Referring to FIG. 1, a cable 100 of the present invention is shown. The cable 100 includes a pair of core wires 10, an insulating layer 20 covering the pair of core wires 10, a shielding layer 30 covering the insulating layer 20, and an outer layer 40 covering the shielding layer 30. Air gaps 50 are formed on the upper and lower sides between the insulating layer 20 and the pair of core wires 10.

The pair of the core wires 10 are in contact with each other and extend in parallel in the longitudinal direction. Each of the core wires 10 includes an inner conductor 11 and an inner insulating layer 12 covering the inner conductor 11. The inner insulating layer 12 includes a first inner insulating layer 121 covering the inner conductor 11 and a second inner insulating layer 122 covering the first inner insulating layer 121. The first inner insulating layer 121 is made of solid material. The second inner insulating layer 122 is made of foamed material. The first inner insulating layer 121 is covered around the inner conductor 11 by extrusion molding. The second inner insulating layer 122 is wrapped around the first inner insulating layer 121 in a winding manner. The material of the first inner insulating layer 121 is any one of PP (polypropylene), PE (polyethylene), and FEP (Fluorinated ethylene propylene). The material of the second inner insulating layer 122 is made of foamed PP and foamed PTFE (Polytetrafluoroethylene). The first inner insulating layer 121 and the second inner insulating layer 122 can be made of the same material, except that one is made of foamed and the other is made of solid material. For example, the first inner insulating layer 121 is made of solid PP material, and the second inner insulating layer 122 is made of foamed PP material. Of course, the first inner insulating layer 121 and the second inner insulating layer 122 can be made of different materials, and one is made of foamed and the other is made of solid material. Preferably, the dielectric constant and loss factor of the second inner insulating layer 122 are both smaller than the dielectric constant and loss factor of the first inner insulating layer 121.

The insulating layer 20 includes a first insulating layer 21 and a second insulating layer 22. The first insulating layer 21 is made of foamed material, and the second insulating layer 22 is made of solid material. The first insulating layer 21 is wrapped around the pair of core wires 10. The second insulating layer 22 is covered around the first insulating layer 21 by extrusion molding. The first insulating layer 21 is made of foamed PP or foamed e-PTFE (foamed polytetrafluoroethylene). The material of the second insulating layer 22 is any one of PP, PE, and FEP. The first insulating layer 21 and the second insulating layer 22 can be made of the same material, except one is foamed and the other is solid, or they can be made of different materials, and one is foamed and the other is not foamed. The dielectric constant and loss factor of the first insulating layer 21 are smaller than that of the second insulating layer 22.

For the same material, the dielectric constant and loss factor of foamed are smaller than those of solid, therefore, when the materials are the same, the foamed material will make the attenuation value of the cable 100 smaller, thereby making the electrical performance of the cable better and conducive to the transmission of high-speed signals. The problem is that if the insulating material is extruded directly onto the cable, the foaming material is not as stable as the solid material process. If the foamed material is directly extruded onto the cable, the extrusion speed will be very slow due to the limitations of the material itself, and the extruded size will also be unstable, which will affect the stability of signal transmission. Moreover, if the foamed material is directly extruded onto the cable, the foaming rate will be lower, with a maximum foaming rate of 50%. Therefore, the foamed material will be made into a tape first and then wrapped. In this way, the process is more stable, the size is uniform, the production efficiency is higher, and the foaming rate can be greater than 50%. If the inner insulating layer 12 of the entire core wire 10 is wrapped with foamed tape, there will be a gap between the surface of the inner conductor 11 and the wrapped inner insulating layer 12. The gap will cause large differential impedance changes. Therefore, in the present invention, the first inner insulating layer 121 is made of solid material and extruded to cover the inner conductor 11, so that the impedance fluctuation is small and the process is relatively stable, then, the second inner insulating layer 122 tape made of foamed material is used to wrap around the first inner insulating layer 121, so that the dielectric constant of the cable 100 is smaller. In addition, if the insulating layer 20 outside the core wire 10 is wrapped, the impedance fluctuation at the bending point will be larger when the cable is bent. Therefore, outside the first insulating layer 21, the second insulating layer 22 is made of a solid material that is easy to be extruded to protect the first insulating layer 21, so that the cable 100 has better bending resistance.

The shielding layer 30 is aluminum-coated PET (polyethylene terephthalate) or copper-coated PET. The shielding layer 30 is covered the second insulating layer 22 in a longitudinal wrapping way or in a spiral winding way. The outer layer 40 is made of PET tape. The outer layer 40 is wrapped around the shielding layer 30 in a spiral winding way. The outer layer 40 may be one or more layers. Specifically, the outer layer 40 of the present invention has two layers. The two layers of outer layer 40 are wound in different directions to offset the stress from each other, making the structure of the cable 100 more stable.

In the cable of the present invention, the inner insulating layer 12 includes a first inner insulating layer 121 and a second inner insulating layer 122 The first inner insulating layer 121 is extruded and molded outside the inner conductor 11 using solid material. The second inner insulation layer 122 is wrapped around the first inner insulation layer 121 with foamed material, in this way, not only the impedance fluctuation of the cable 100 is smaller, but also the dielectric constant of the cable 100 is smaller. Furthermore, the first insulating layer 21 is wrapped around the core wire 10 with a foamed tape, and the second insulating layer 22 is extruded and molded outside of the first insulating layer 21 using solid material, so that the cable 100 has a lower dielectric constant and better bending resistance.

1. A cable comprising:
a pair of core wires each including an inner conductor and an inner insulating layer covering the inner conductor;
an insulating layer covering the pair of core wires;
a shielding layer covering the insulating layer; and
an outer layer covering the shielding layer; wherein
the inner insulating layer includes a first inner insulating layer covering the inner conductor and a second inner insulating layer covering the first inner insulating layer, the first inner insulating layer is made of solid material and covers the inner conductor by extrusion molding, the second inner insulating layer is made of foamed material and wraps the first inner insulating layer in a winding way, the insulating layer includes a first insulating layer and a second insulating layer, the first insulating layer covers the pair of core wires in a winding way, and the second insulating layer covers the first insulating layer by extrusion molding.

2. The cable as claimed in claim 1, wherein the dielectric constant and loss factor of the second inner insulating layer are both smaller than the dielectric constant and loss factor of the first inner insulating layer, the dielectric constant and loss factor of the first insulating layer are both smaller than the dielectric constant and loss factor of the second insulating layer.

3. The cable as claimed in claim 1, wherein the first insulating layer is made of foamed material, and the second insulating layer is made of solid material.

4. The cable as claimed in claim 1, wherein the first insulating layer and the second insulating layer are made of same material, except that one is foamed and the other is solid, and the first inner insulating layer and the second inner insulating layer are made of same material, except that one is foamed and the other is solid.

5. The cable as claimed in claim 1, wherein the second inner insulating layer is made of foamed PP or foamed PTFE.

6. The cable as claimed in claim 1, wherein the first inner insulating layer is selected from the group consisting of PP, PE, foamed PP, and foamed FEP.

7. The cable as claimed in claim 1, wherein the first insulating layer is made of foamed PP or foamed PTFE.

8. The cable as claimed in claim 1, wherein the second insulating layer is selected from the group consisting of PP, PE, foamed PP, and foamed FEP.

9. The cable as claimed in claim 1, wherein the shielding layer is aluminum-coated PET or copper-coated PET.

10. The cable as claimed in claim 1, wherein the outer layer is made of one or more layers of PET tape.
